(19) United States
(12) Patent Application Publication
(10) Pub. No.: US 2018/0057337 A1
(43) Pub. Date: Mar. 1, 2018

(54) Mixed Drink Producing Apparatus With A Manipulation Device For Manipulating An Orientation Of A Jet Of A Liquid Of The Mixed Drink, Household Refrigeration Apparatus As Well As Method For Producing And Dispensing A Mixed Drink

(71) Applicant: BSH HAUSGERAETE GMBH, MUENCHEN (DE)

(72) Inventors: ANDREAS BABUCKE, HEIDENHEIM (DE); KUDRET BAYSAL, GIENGEN BRENZ (DE); CHRISTIAN MAYERSHOFER, GUNDREMMINGEN (DE); CARSTEN WEISS, GIENGEN (DE)

(21) Appl. No.: 15/252,516

(22) Filed: Aug. 31, 2016

(51) Int. Cl. B67D 1/00; B67D 1/08; F25D 23/12

(52) U.S. Cl. CPC B67D 1/0052; B67D 1/0021; F25D 23/12; B67D 1/0878; B67D 1/0078

(57) ABSTRACT

A mixed drink producing apparatus with a dispensing container, which is formed for receiving a liquid addable to a mixed drink by the mixed drink producing apparatus and which is connected to a dispensing unit of the mixed drink producing apparatus for conducting the liquid from the dispensing container to the dispensing unit, wherein the dispensing unit has a dispensing opening, from which the mixed drink can be dispensed, and the mixed drink producing apparatus has a gas adding unit, which is disposed such that a gas output by it is directed to a jet of the liquid dispensed from the dispensing container and the gas is addable to the jet before the dispensing opening such that the orientation of the jet after the dispensing opening is variable by the gas addition. The invention also relates to a household refrigeration apparatus and to a method for producing and dispensing a mixed drink.

### TECHNICAL FIELD

The invention relates to a mixed drink producing apparatus with a dispensing container formed for receiving a liquid addable to a mixed drink by the mixed drink producing apparatus. The mixed drink producing apparatus moreover includes a dispensing unit, to which the dispensing container is connected for supplying the liquid from the dispensing container to the dispensing unit. Furthermore, the invention also relates to a household refrigeration apparatus with such a mixed drink producing apparatus as well as to a method for producing and dispensing a mixed drink.

### PRIOR ART

From DE 196 15 106 A1, a method and a device for continuously producing soda water or soda-like water are known. A device is disclosed there, in which different liquids like lemonade, beer, wine can be present in different separate containers. Each container is connected to an own tap and is thus separated from the other container. Producing and dispensing a mixed drink of different liquids in the containers is not possible there in the interior of the system itself. Furthermore, the taps are far apart such that introducing liquids from different taps into a drinking vessel at the same time is not possible.

From WO 2007/141321 A2, a household refrigeration apparatus is known, which has a drink apparatus, which is formed for dispensing a drink at this household refrigeration apparatus itself.

Moreover, cold drink machines are also known, in which alcohol containing mixed drinks, for example cocktails, can be dispensed.

In known mixed drink producing apparatuses for dispensing cooled drinks, mixing of the liquid jet with other additions upon dispensing is restricted.

### BRIEF SUMMARY OF THE INVENTION

It is the object of the present invention to provide a mixed drink producing apparatus as well as a household refrigeration apparatus as well as a method for producing a mixed drink, by which or in which the preparation of cooled mixed drinks is improved.

This object is solved by a mixed drink producing apparatus, a household refrigeration apparatus and a method according to the independent claims.

A mixed drink producing apparatus according to the invention includes a dispensing container, which is formed for receiving a liquid addable to an in particular cooled mixed drink by the mixed drink producing apparatus. The mixed drink producing apparatus moreover includes a dispensing unit, which is formed for dispensing the liquid or the mixed drink. The dispensing container is connected to the dispensing unit in fluid conducting manner such that the liquid can be conducted from the dispensing container to the dispensing unit. An essential idea of the invention is to be regarded in that the dispensing unit has a dispensing opening, from which the mixed drink can be dispensed. The mixed drink producing apparatus moreover includes a gas adding unit, which is arranged such that a gas output by it is directed towards a jet of the liquid dispensed from the dispensing container and the gas can be added to the jet before the dispensing opening such that the orientation of the jet is variable or manipulable at least after the dispensing opening by the gas addition. Therefore, the gas adding unit with its medium to be output is a manipulation device, by which the directional orientation of the jet of the liquid is variable in defined and intended manner, namely after exit from the dispensing opening. By this configuration, the liquid jet from the dispensing container is specifically varied in defined manner to meet with an addition medium, which is added from a further separate container, in particular a capsule, to a mixed drink, before arriving at a drinking vessel. Thereby, an already considerably improved mixed jet of mixed drink arrives at the drinking vessel.

In particular, it is provided that the gas to be added to the jet is air. This manipulation medium is generally present everywhere and can then also be simply used to manipulate the orientation of the jet. Additional special gases then do not have to be provided such that installation space can here also again be saved, which would arise for containers, in which special gases would have to be present.

Preferably, it is provided that the gas adding unit is a pump. It is very simply constructed and permanently functionally reliable. Moreover, the operating principle of a pump is very simple such that the susceptibility to errors is reduced here too and moreover a very compact unit can also be provided.

In particular if the gas to be added is air, which can be readily taken from the environment, the implementation of a pump is particularly advantageous since it can simply suck the ambient air and then again blow it out in defined direction to the jet.

Preferably, it is provided that the pump is connected to a decompression chamber of the mixed drink producing apparatus formed for pressure reduction of a carbonized first liquid. In particular if such a decompression chamber is thus present, the use of a present gas is particularly advantageous, which is then also provided in defined manner and specific amount and can then be sucked by the pump in defined manner and be taken in the direction of the jet of the first liquid. Thus, such a decompression chamber is in particular advantageously present in a configuration, in which the mixed drink has at least one carbonized liquid ingredient thus enriched with carbon dioxide. In particular, such an enrichment with carbon dioxide is effected via a corresponding cartridge, which is present in the mixed drink producing apparatus. Therein, the liquid enriched with carbon is in particular arranged in a reservoir of the mixed drink producing apparatus and is then conducted out of this reservoir before introduction into the dispensing container and conducted into the decompression chamber, where it is expanded and brought to a lower pressure, in an advantageous implementation. Since the pressure of the enriched liquid in the reservoir is too high for specific and in particular splash-free dispensing via the dispensing unit, such a decompression is advantageous. In this context, it can be provided that the decompression chamber is brought to a defined pressure level with carbon dioxide for expanding this carbonized liquid at a higher pressure. Thereafter, the amount of carbonized liquid required for drink preparation is conducted from its reservoir with high pressure there, which can for example be at about 4 bar, into the corresponding decompression chamber at medium pressure, which can for example be between 2 and 2.5 bar. The carbon dioxide displaced therein can be intermediately stored and be reused. The carbon dioxide remaining in the decompression chamber is for example released to the environment via a throttle valve. Since the decompression chamber is configured for the liquid amount maximally required for the drink preparation, relatively much carbon dioxide is lost in this configuration especially in the preparation of small drinks.

Therefore, in an advantageous implementation, it is then provided that the decompression chamber is brought to a defined pressure level with ambient air, wherein the mentioned pump, in particular the air pump, is then preferably employed in this configuration. Thus, in such a configuration, as it was set out above as an advantageous implementation, a pump is used in multi-functional manner. It is then formed for generating a desired pressure level in the decompression chamber by introducing ambient air on the one hand, for manipulating an orientation of the liquid jet dispensed from the dispensing container with ambient air by the pump on the other hand.

In particular, it is provided that the mixed drink producing apparatus has a control unit, by which the period of time of gas addition and/or the amount of the gas to be added are adjustable depending on the volume flow of the jet of the liquid. This is a further very advantageous implementation, since the addition of the gas can thus be very adequately effected and therefore the orientation of the jet of the liquid after exit from the dispensing opening can be manipulated in very individual manner and adapted to situation. Thereby, also with different configurations of the jet of the liquid, a virtually identical orientation of this jet can then always still be achieved, which particularly advantageously results in a then desired, always substantially identical point of meeting of the jet with the jet of the addition medium from a capsule in particular separate therefrom. Mixing of this exiting liquid jet from the dispensing opening with the jet of the addition medium from the capsule is then always allowed in very defined manner at a local place, in particular then also before entry into a drinking vessel such that upon entry into the drinking vessel, an already considerably improved mixing of the jet of the liquid with the addition medium is then achieved.

In particular, it is provided that the gas addition unit has at least two nozzles, from which the gas can be passed to the jet. This is an improved implementation to the effect that the local and/or quantitative addition of the gas to the jet can be more individually effected and thus the variation of the orientation of the jet is even more precisely allowed.

Preferably, it is provided that the mixed drink producing apparatus has a capsule separate from the dispensing container and from the gas adding unit with an addition medium, which can be added to the jet of the liquid for producing the mixed drink. Such an addition medium can be liquid, gelatinous or powdery. In this context, addition media individual both in taste and in color can then be present, which impart corresponding specifications to the mixed drink.

In particular, it is provided that the orientation of the jet of the liquid is adjusted by the gas admixture such that the jet of the liquid mixed with the gas meets with the jet of the addition medium from the capsule in a defined height position after the dispensing opening. The advantages achievable thereby were already above stated.

In particular, it is provided that the defined height position is above an upper edge of a receiving vessel or drinking vessel placed below the dispensing opening. The advantages achievable thereby were also already above mentioned.

In particular, it is provided that the mixed drink producing apparatus has a mixing element, by which the gas added to the jet can be mixed with the liquid. Thereby, the mixing becomes more uniform and the orientation manipulation becomes more accurate and it is thereby also achieved that the orientation variation then remains identically oriented for a longer period of time, in particular for the period of time of dispensing the mixed drink. Undesired abrupt variations of the orientation of the jet of the liquid can thereby be avoided, whereby the mixing of the jet of the liquid with the jet of the addition medium also is effected very uniformly for the period of time of dispensing these two jets.

In particular, it is provided that the mixing element is an aerator or a mixing nozzle, by which the jet with the added gas can be conducted.

Preferably, it is provided that the dispensing opening is adjustable in its opening width and/or its angular position for manipulating the orientation of the jet of the liquid. These are further additional possibilities of achieving the precision of the orientation variation of the jet and the adjustment of the orientation of the jet, respectively, and once again improving especially the point of impingement or the place of meeting with the jet of the addition medium.

In particular, it is provided that the mixed drink producing apparatus has at least one second dispensing container, which is formed for receiving a second liquid addable to the in particular cooled mixed drink by the mixed drink producing apparatus, wherein this second dispensing container is connected to the dispensing unit of the mixed drink producing apparatus for conducting the second liquid from the second dispensing container to the dispensing unit, wherein the first liquid and the second liquid are mixed with the jet dispensed from the dispensing opening. In this configuration, a mixed drink of two different liquids thus is already present at the dispensing opening, which can then in particular be mixed with the jet of the addition medium from the capsule.

It can be provided that a liquid, in particular the first liquid, is water or contains water and the second liquid is alcohol or contains alcohol.

In particular, the two liquids also have different freezing points.

In particular, the first dispensing container is cooled by a cooling device of the mixed drink producing apparatus. The cooling device is in particular a refrigeration circuit. The refrigeration circuit in particular includes an evaporator, which is thermally coupled to the dispensing container, such that the dispensing container can be cooled by the cold energy of the evaporator and thus the first liquid in particular present in the dispensing container is thereby then also cooled.

In particular, the preferably present second dispensing container can also be cooled by the cooling device. Here too, the thermal coupling to a refrigeration circuit is in particular provided, which is preferably the refrigeration circuit, by which the first dispensing container is also cooled. Here too, it is preferably provided that the second dispensing container is thermally coupled to an own, separate evaporator and is cooled via the cold energy thereof. Especially if the two liquids have different freezing points, the cooling with separate cooling units, in particular separate evaporators, is advantageous to be able to individually adjust adequate temperatures without one of the two liquids freezing.

A further independent aspect of the invention relates to a mixed drink producing apparatus with a dispensing container, which is formed for receiving a liquid addable to an in particular cooled mixed drink by the mixed drink producing apparatus, wherein the dispensing container is connected to a dispensing unit of the mixed drink producing apparatus for conducting the liquid from the dispensing container to the dispensing unit. An essential idea of this further independent aspect of the invention is to be regarded in that the dispensing unit has a dispensing opening, from which the mixed drink can be dispensed, and the dispensing opening is adjustable in its opening width and/or its angular position for manipulating the orientation of the jet of the liquid after the dispensing opening in defined manner. The advantages achievable thereby were already above mentioned.

Implementations of the first independent aspect of the invention concerning the mixed drink producing apparatus are to be regarded as advantageous implementations of this second independent aspect of the mixed drink producing apparatus.

Furthermore, the invention also relates to a household refrigeration apparatus for storing and preserving food, which has a housing, in which a receiving space for food is formed. The household refrigeration apparatus moreover includes a mixed drink producing apparatus according to the first independent aspect of the invention or according to the second independent aspect of the invention. The household refrigeration apparatus can be a refrigerator or a freezer or a combined refrigerator-freezer.

Furthermore, the invention also relates to a method for producing and dispensing a mixed drink with a mixed drink producing apparatus, which is formed with a dispensing container, which is formed for receiving a liquid addable to an in particular cooled mixed drink by the mixed drink producing apparatus and which is connected to a dispensing unit of the mixed drink producing apparatus for conducting the liquid from the dispensing container to the dispensing unit. An essential idea of the method is to be regarded in that a jet at least of the liquid is dispensed from a dispensing opening of the dispensing unit and an addition medium from a capsule separate from the dispensing container is dispensed from the capsule for producing the mixed drink, wherein the jet of the liquid is manipulated in its orientation by a manipulation unit of the mixed drink producing apparatus in defined manner such that the jet meets with the jet of the addition medium in a defined height or a defined height position after exit from the dispensing opening. In particular, this manipulation of the orientation of the jet is effected such that a place of meeting of the jet of the liquid and the jet of the addition medium is effected before entry into a receiving vessel such that mixing of the liquid with the addition medium is already effected before reaching the receiving vessel.

The manipulation unit can be a gas adding unit, wherein the manipulation medium is then a gas. However, the manipulation device can also be a unit, by which the opening width of the dispensing opening of the dispensing unit is variable and/or an angular position of this dispensing opening is variable relative to a base position and thus is also adjustable relative to a recess, in particular a ceiling wall of a recess. The receiving vessel can be placed in this recess to then be able to receive the dispensed, cooled mixed drink.

Advantageous implementations of the mixed drink producing apparatus according to the invention are to be regarded as advantageous implementations of the method according to the invention, wherein the respective objective features of the mixed drink producing apparatus are thereto formed for performing the method steps.

In addition, it can also be provided that the mixed drink producing apparatus is formed for receiving a capsule, in which additives, which can be added to the mixed drink, are contained. Additives can be powdery or gelatinous or also liquid. In this context, the capsule can then be inserted into a dispensing area of the mixed drink producing apparatus and this ingredient of the capsule can then also be automatically dispensed or added or already be added upon dispensing the mixed drink.

In an advantageous implementation, it is provided that the mixed drink producing apparatus is disposed in a receiving area of the household refrigeration apparatus in particular separate from the receiving space for food. This receiving area can be formed in an interior container bounding the receiving space with its walls. However, it can also be provided that the receiving area is formed in an interior container separate from this interior container bounding the receiving space with its walls. These interior containers or this interior container are or is disposed in the housing.

The receiving space, in particular only the receiving space, is closable on the front side by a door pivotably supported at the housing. In this context, it can be provided that the household refrigeration apparatus is formed such that only one receiving space is present, which is for example a refrigerating compartment or a freezing compartment, which is closable by an own door. However, it can also be provided that such a single receiving space is closable by two doors, which are swing doors. However, it is similarly possible that with two separate receiving spaces, for example a refrigerating space and a freezing space, each of these receiving spaces is closable by a separate door.

Preferably, the mixed drink producing apparatus is accessible and exposed on the front side and not closed and covered by a door.

In an advantageous implementation, it is provided that the mixed drink producing apparatus is arranged drawer-like in the receiving space and thus is retractable and extractable in depth direction of the household refrigeration apparatus. Thereby, the operability for dispensing mixed drinks can be simplified. An essential advantage of this configuration is to be regarded in that the accessibility to the housing of the mixed drink producing apparatus is simplified. In particular the accessibility to the containers and/or other further components in the housing is thereby allowed. It can then be provided that in the extracted state the interior of the housing of the mixed drink producing apparatus can be accessed for example via openings in side walls closable by flaps.

The drink producing apparatus is also to be referred to as mixed drink producing apparatus if the drink to be dispensed has at least one liquid and an addition medium or at least two different liquids.

With indications of “top”, “bottom”, “front”, “rear”, “horizontal”, “vertical”, “depth direction”, “width direction”, “height direction” etc., the positions and orientations with intended use and intended arrangement of the apparatus and with an observer then standing in front of the apparatus and looking towards the apparatus are specified.

Further features of the invention are apparent from the claims, the figures and the description of figures. The features and feature combinations mentioned above in the description as well as the features and feature combinations mentioned below in the description of figures and/or shown in the figures alone are usable not only in the respectively specified combination, but also in other combinations without departing from the scope of the invention. Thus, implementations are also to be considered as encompassed and disclosed by the invention, which are not explicitly shown in the figures and explained, but arise from and can be generated by separated feature combinations from the explained implementations. Implementations and feature combinations are also to be considered as disclosed, which thus do not have all of the features of an originally formulated independent claim. Moreover, implementations and feature combinations are to be considered as disclosed, in particular by the implementations set out above, which extend beyond or deviate from the feature combinations set out in the relations of the claims.

### BRIEF DESCRIPTION OF THE DRAWINGS

Below, embodiments of the invention are explained in more detail based on schematic drawings. There show:

FIG. 1 a perspective partial representation of an embodiment of a household refrigeration apparatus according to the invention;

FIG. 2 a schematic representation of a jet of an at least first liquid and a jet of an addition medium; and

FIG. 3 a schematic representation of an implementation of a manipulation unit for manipulating an orientation of a jet of the at least first liquid after exit from a dispensing opening.

### PREFERRED EMBODIMENTS OF THE INVENTION

In the figures, identical or functionally identical elements are provided with the same reference characters.

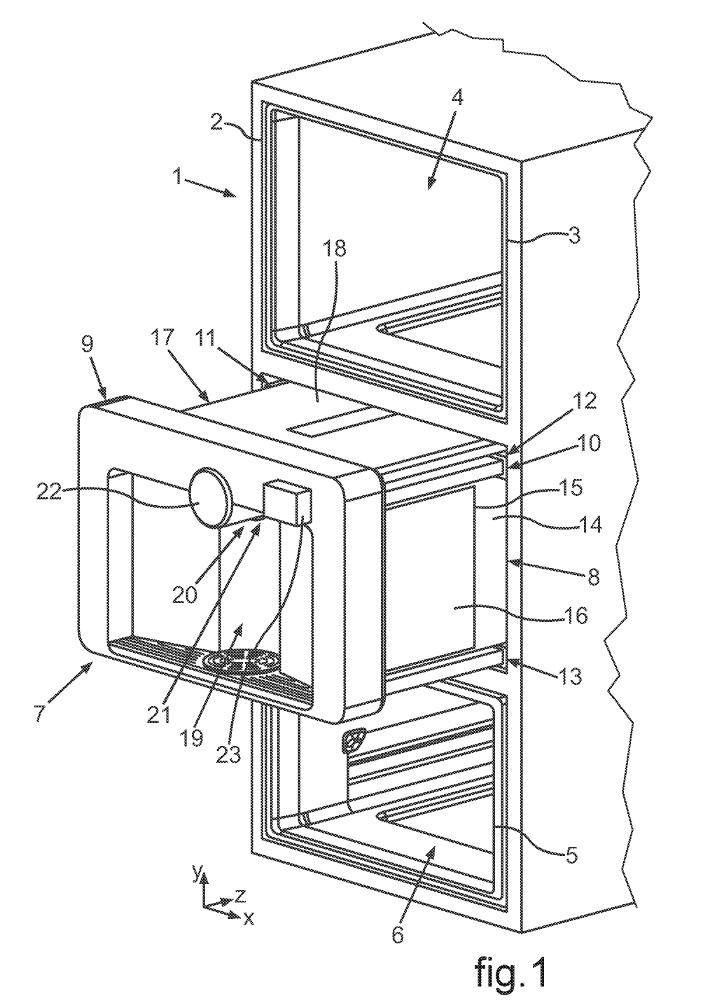

In FIG. 1, a household refrigeration apparatus 1 is illustrated in certain areas in a simplified perspective representation. Here, the household refrigeration apparatus 1 is for example a combined refrigerator-freezer. The household refrigeration apparatus 1 is formed for storing and preserving food. It includes a housing 2, in which a first interior container 3 is disposed. Walls of the interior container 3 bound a first receiving space 4 for food, wherein this receiving space 4 is a refrigerating compartment.

Moreover, the household refrigeration apparatus 1 includes a further interior container 5, which bounds a second receiving space 6 with its walls, which is a freezing compartment. The two receiving spaces 4 and 6 are separated from each other. In the shown embodiment, the receiving spaces 4 and 6 are disposed one above the other in vertical direction and thus in height direction (y-direction). In the embodiment, they are preferably closable by non-shown, respectively separate doors, which are in particular pivotably fastened to the housing 2.

Moreover, the household refrigeration apparatus 1 includes a mixed drink producing apparatus 7.

However, the mixed drink producing apparatus 7 can also be formed as a separate independent apparatus and thus be installed independently of a household refrigeration apparatus 1 and operable independently thereof.

The mixed drink producing apparatus 7 is disposed in a receiving area 8 of the housing 2. This receiving area 8 is separated from the receiving spaces 4 and 6. It can be provided that the receiving area 8 is bounded by walls of a separate interior container, which is also foamed in the housing 2. However, the receiving area 8 can also be formed integrated in the interior container 3 or the interior container 5.

In the embodiment, it is provided that the receiving area 8 is disposed between the receiving space 4 and the receiving space 6 in height direction.

The mixed drink producing apparatus 7 is disposed accessible from the front side and thus from the front and the visible side. In particular, it is not closable and thus not coverable on the front side by a door.

The mixed drink producing apparatus 7 has a housing 9.

In the embodiment, it is provided that the housing 9 and thus the entire mixed drink producing apparatus 7 can be extracted from and again retracted into the receiving area 8 in depth direction and thus in horizontal direction corresponding to the z-direction corresponding to a drawer. In FIG. 1, the completely extracted state is shown.

Here, it is preferably provided that the horizontal displaceability is formed by a displacing device 10, which has multiple supporting positions. In the embodiment, it is provided that the displacing device 10 includes at least two, in particular four supporting positions. In the embodiment, they are formed as rails, which can also be extraction rails. In particular, here are disposed a first rail 11 in an upper left corner area, a second rail 12 in the upper right corner area, a third rail 13 in the lower right corner area and a further rail not recognizable in FIG. 1 in the lower left corner area. By this four-position support, a very secure and spread- and tilt-proof displacement, respectively, of the housing 9 is allowed.

Thus, the mixed drink producing apparatus 7 is advantageously displaceably supported in the interior container 8. Advantageously, the displacing device 10 also has an extraction stop, by which the drink apparatus formed in particular as a mixed drink producing apparatus 7 is secured in position in a completely extracted position shown in FIG. 1. Thus, over-extraction cannot be effected such that the mixed drink producing apparatus 7 cannot fall out to the front and tilt downwards, respectively.

Advantageously, it is also provided that the displacing device 10 has a displacing protection, by which the mixed drink producing apparatus 7 is disposed extraction-secured in the position completely retracted into the receiving area 8. Thereby too, undesired slipping out or protruding to the front then present is avoided. Undesired leakage or dripping of a liquid or hitting thereto is thereby prevented. This displacement protection can be a locking device. However, in addition or instead of it, a magnetic mount can also be provided.

Advantageously, an access 15 is formed at a vertical sidewall 14 of the housing 9, which is closed by a flap 16. After opening the flap 16, the interior of the housing 9 can be accessed such that the simple and unrestricted accessibility is allowed for purposes of exchange or filling. Additionally or instead of it, it can also be provided that a corresponding access is formed at an opposing further vertical sidewall 17 and/or at least one such access 15 is formed at a ceiling wall 18 of the housing 9.

Moreover, the mixed drink producing apparatus 7 includes a recess or placing bay 19 on the front side, into which a drinking vessel can be placed, by which the mixed drink to be produced and dispensed by the mixed drink producing apparatus 7 can then be collected. The mixed drink producing apparatus 7 includes a dispensing unit 20 with in particular a single outlet or a dispensing opening 21. Preferably, it can be provided that an own outlet is respectively present for discharging each liquid from a container. Moreover, it can also be provided that an additive in powder form or gel form or further liquid form can be admixed to this mixed drink to be produced, which can be produced and thus mixed from at least two different liquids. Thereto, it can in particular be provided that a capsule receptacle 22 is formed, into which a capsule having the mentioned additive or an addition medium can be inserted. Upon dispensing the mixed drink, this ingredient or additive is then removed from the capsule and added to the mixed drink in particular after dispensing into the drinking vessel effected via the dispensing opening 21.

Moreover, it can in particular be provided that the mixed drink producing apparatus 7 has a capsule storage 23 or a capsule stock. A capsule or multiple capsules can be stored in this capsule storage 23 such that they are always present locally at the apparatus itself. In an advantageous implementation, it can be provided that this capsule storage 23 is cooled such that the capsules located therein can also be stored correspondingly cooled.

Preferably, it is provided that the capsule storage 23 can be opened by push-push mechanics and the capsules received therein are then freely accessible for example in the form of a displaceable storage in the form of a rail and for example can then be simply removed from above.

Moreover, it can also be provided that the mixed drink producing apparatus 7 has a cartridge for admixing carbon dioxide into the mixed drink. Thereto, the accessibility for cartridge exchange is allowed via at least one present access 15. In an advantageous implementation, it is provided that the mixed drink producing apparatus 7 is connected to a water connection external to household apparatus such that supply of water is for example allowed via a house water network. This has the additional advantage that a liquid to be added to the mixed drink as water does not have to be stored in a largely dimensioned container in the mixed drink producing apparatus 7 but that this container can then be smaller dimensioned and can be refilled depending on demand and adapted to situation. It can then also be provided that such a water supply for producing the mixed drink is not supplied from the tank or the container provided for receiving this liquid in the mixed drink producing apparatus 7, but additionally or instead thereof can also be passed directly from this line to the dispensing unit 20 and thus also to the dispensing opening 21.

Thereby, in particular in production of hot drinks instead of a cold drink, the required energy for heating is reduced since the initial temperature of the water is higher. If carbonization of the mixed drink should then be desired, thus, this can be allowed via admixture of carbonized cold water, which is cooled in the mixed drink producing apparatus 7, or via a carbonized second liquid, which is then present in the second container.

It is in particular provided that the mixed drink producing apparatus 7 has a first container, in which a first liquid with a first freezing point, in particular water, is then provided or stored to then provide it for producing and dispensing a mixed drink depending on demand. Moreover, the mixed drink producing apparatus 7 includes a second container separated therefrom, which is formed for receiving a second liquid different from the first liquid, which has a freezing point different form the first liquid. In particular, the first liquid is water and the second liquid is alcohol such that the mixed drink can also be an alcoholized mixed drink.

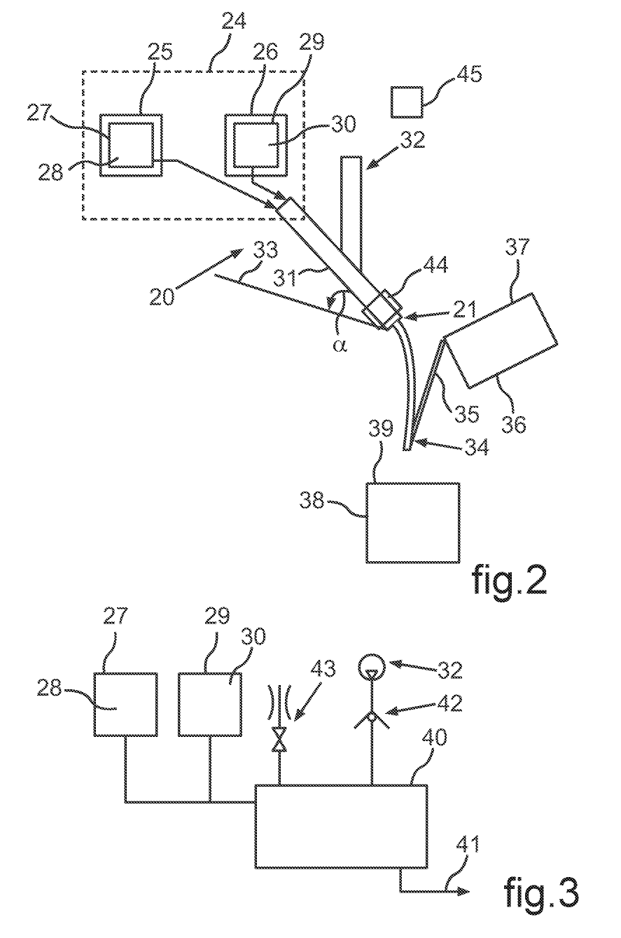

In FIG. 2, the household refrigeration apparatus 1 is shown with partial components of the mixed drink producing apparatus 7 in a schematic representation. The household refrigeration apparatus 1 includes a refrigeration circuit 24, which is in particular a refrigeration circuit of the mixed drink producing apparatus 7. In an advantageous implementation, this refrigeration circuit 24 includes a non-illustrated condenser, a compressor as well as a first evaporator 25 and a second evaporator 26 separate therefrom. The mixed drink producing apparatus 7 includes a first container or dispensing container 27, which is formed for receiving the first liquid 28 addable to the mixed drink, in the embodiment. The first dispensing container 27 is thermally coupled to the refrigeration circuit 24, in particular thermally coupled to the first evaporator 25. In an advantageous implementation, the first evaporator 25 surrounds the first dispensing container 27 on the outer side thereof at least in certain areas.

In the embodiment, it is provided that the mixed drink producing apparatus 7 has a second container or dispensing container 29 separate from the first dispensing container 27, which is formed for receiving a second liquid 30 different from the first liquid, which can also be added to the mixed drink. Here too, it is preferably provided that the second evaporator 25 is thermally coupled to the second dispensing container 29, in particular surrounds it on the outer side thereof at least in certain areas.

In particular, it is provided that the first liquid 28 is or has water and the second liquid 30 is or contains alcohol.

In FIG. 2, dispensing of the two liquids 28 and 30 from the dispensing containers 27 and 29 is then illustrated by arrows in sketchy manner in the schematic representation, and the two liquids 28 and 30 are mixed to a common liquid jet 31 in an advantageous implementation. However, dispensing of a jet of only one of the two liquids 28 and 30 can also be provided. It is provided that the jet 31 can be manipulated in its orientation after exit from the dispensing opening 21 by a manipulation device of the household refrigeration apparatus 1. Preferably, the manipulation device can be a gas adding unit 32, in particular a pump like an air pump. In particular, ambient air is then sucked by the pump and added to the jet 31 in such a configuration such that the orientation of this jet 31 can be specifically varied by this gas addition.

Preferably, it is provided, as it is schematically shown in FIG. 2, that the gas addition is effected before reaching the dispensing opening 21.

For manipulating the orientation and thus the jet width of the jet or the arc shape of the jet 31 after exit from the dispensing opening 21, it can additionally or instead also be provided that the manipulation device 32 is formed to increase or reduce the opening width of the dispensing opening 21 in defined manner and/or an angular position of the angle α of the dispensing opening 21 is variable in defined manner. In this context, the angle α is measured between the jet 31 and a wall 33, at which the dispensing opening 21 is arranged.

Therein, it is in particular provided that this width orientation of the jet 31 after exit from the dispensing opening 21 and thus also the arc size or spraying extent of this jet 31 is preset such that a place of meeting 34 with a jet 35 of an additive or addition medium 36, which is contained in a capsule 37 disposed in the mixed drink producing apparatus 7, is formed after the dispensing opening 21, but before entry into a receiving vessel 38 with regard to the height position viewed in vertical direction. In particular, this place of meeting 34 is above an edge 39 of the receiving vessel 38 in vertical direction. Desired improved mixing between the jet 31 and the jet 35 then already before entry into the receiving vessel 38 is thereby achieved.

Therein, the receiving vessel 38 is placed in the placing bay 19 (FIG. 1).

In an advantageous implementation, it is provided that the manipulation unit 32 then in particular formed as an air pump is also formed for conveying ambient air into at least one decompression chamber 40. This at least one decompression chamber 41 is in particular present if the mixed drinks capable of being dispensed by the mixed drink producing apparatus 7 can also be carbonized and thus can have carbon dioxide. In this context, it can for example be provided that the first liquid 28 and/or the second liquid 30 can be carbonized and are present at a corresponding larger pressure in the dispensing containers 27 and 29 in this context. In order to then achieve pressure reduction and thus decompression here, the liquid 28 and/or the liquid 30 are conducted into the decompression chamber 40 before reaching the dispensing opening 21 to there achieve pressure reduction, in particular to about 2 bar to 2.5 bar. From the decompression chamber 40, the mixed drink is then conducted to the dispensing opening 21 via a line 41. In FIG. 3, a check valve 42 as well as a throttle valve 43 are also exemplarily drawn. The gas amount associated with the decompression can be exhausted via the throttle valve 43. The decompression chamber 40 is in particular connected to the dispensing container 27, 29, in which a carbonized liquid is contained. If both liquids are carbonized, two separate decompression chambers are preferably present, which are each connected to one of the dispensing containers 27, 29.

The gas addition unit in the form of the air pump can also have at least two nozzles, from which the gas, in particular the ambient air, can be passed to the jet 31.

In addition, it can also be provided that the mixed drink producing apparatus 7 has a mixing element, which can be an aerator or a mixing nozzle, wherein this mixing element 44 (FIG. 2) is preferably disposed before the outlet opening 21 such that mixing of the jet 31 with the gas is improved in this mixing element.

The mixed drink producing apparatus 7 also includes a control unit 45 for controlling the dispensing of the mixed drink. In particular, the control unit 45 also controls the manipulation device 32. In particular, the control unit is also formed for controlling the opening width and/or the angular position of the dispensing opening 21. The control unit 45 is then also a manipulation device for manipulating the orientation of the jet 31.

### LIST OF REFERENCE CHARACTERS

1 Household refrigeration apparatus
2 housing
3 interior container
4 first receiving space
5 interior container
6 second receiving space
7 mixed drink producing apparatus
8 receiving area
9 housing
10 displacing device
11 rail
12 rail
13 rail
14 sidewall
15 access
16 flap
17 sidewall
18 ceiling wall
19 placing bay
20 dispensing unit
21 outlet
22 capsule receptacle
23 capsule storage
24 refrigeration circuit
25 first evaporator
26 second evaporator
27 first dispensing container
28 first liquid
29 second dispensing container
30 second liquid
31 jet
32 gas adding unit
33 wall
34 place of meeting
35 jet
36 addition medium
37 capsule
38 receiving vessel
39 edge
40 decompression chamber
41 line
42 check valve
43 throttle valve
44 mixing element
45 control unit
α angle

1. A mixed drink producing apparatus, comprising:
a dispensing unit for dispensing liquid from the mixed drink producing apparatus,
a dispensing container, which is formed for receiving a liquid addable to a cooled mixed drink by the mixed drink producing apparatus, wherein
the dispensing container is connected to a dispensing unit of the mixed drink producing apparatus for conducting the liquid from the dispensing container to the dispensing unit,
the dispensing unit has a dispensing opening, from which the mixed drink can be dispensed, and
the mixed drink producing apparatus has a gas adding unit, which is disposed such that a gas output by it is directed to a jet of the liquid dispensed from the dispensing container and the gas can be added to the jet before the dispensing opening such that the orientation of the jet after the dispensing opening is variable by the gas addition.

2. The mixed drink producing apparatus according to claim 1, wherein the gas to be added to the jet is air.

3. The mixed drink producing apparatus according to claim 1, wherein the gas adding unit is a pump.

4. The mixed drink producing apparatus according to claim 3, wherein the pump is connected to a decompression chamber of the mixed drink producing apparatus formed for pressure reduction of a carbonized liquid.

5. The mixed drink producing apparatus according to claim 1, wherein the mixed drink producing apparatus has a control unit, by which the period of time of gas addition and/or the amount of the gas to be added are adjustable depending on the volume flow of the jet of the liquid.

6. The mixed drink producing apparatus according to claim 1, wherein the gas adding unit has at least two nozzles, from which the gas can be passed to the jet.

7. The mixed drink producing apparatus according to claim 1, wherein the mixed drink producing apparatus has a capsule with an addition medium separate from the dispensing container and from the gas adding unit, which can be added to the jet of the liquid for producing the mixed drink.

8. The mixed drink producing apparatus according to claim 7, wherein the orientation of the jet of the liquid is adjusted by the gas admixture such that the jet mixed with the gas meets with the jet of the addition medium from the capsule in a defined height position after the dispensing opening.

9. The mixed drink producing apparatus according to claim 8, wherein the defined height position is above an upper edge of a receiving vessel placed below the dispensing opening.

10. The mixed drink producing apparatus according to claim 1, wherein the mixed drink producing apparatus has a mixing element, by which the gas added to the jet can be mixed with the liquid.

11. The mixed drink producing apparatus according to claim 10, wherein the mixing element is an aerator or a mixing nozzle, by which the jet with the added gas can be conducted.

12. The mixed drink producing apparatus according to claim 1, wherein the dispensing opening is adjustable in its opening width and/or its angular position for manipulating the orientation of the jet of the liquid.

13. The mixed drink producing apparatus according to claim 1, wherein the mixed drink producing apparatus has at least a second dispensing container, which is formed for receiving a second liquid addable to the mixed drink by the mixed drink producing apparatus and which is connected to the dispensing unit of the mixed drink producing apparatus for conducting the second liquid from the second dispensing container to the dispensing unit, wherein the first liquid and the second liquid are mixed to the jet.

14. A household refrigeration apparatus with a housing, in which a receiving space for food is formed, and with a mixed drink producing apparatus having:
a dispensing unit for dispensing liquid from the mixed drink producing apparatus,
a dispensing container, which is formed for receiving a liquid addable to a cooled mixed drink by the mixed drink producing apparatus, wherein
the dispensing container is connected to a dispensing unit of the mixed drink producing apparatus for conducting the liquid from the dispensing container to the dispensing unit,
the dispensing unit has a dispensing opening, from which the mixed drink can be dispensed, and
the mixed drink producing apparatus has a gas adding unit, which is disposed such that a gas output by it is directed to a jet of the liquid dispensed from the dispensing container and the gas can be added to the jet before the dispensing opening such that the orientation of the jet after the dispensing opening is variable by the gas addition.

15. A mixed drink producing apparatus having:
a dispensing unit for dispensing liquid from the mixed drink producing apparatus,
a dispensing container, which is formed for receiving a liquid addable to a cooled mixed drink by the mixed drink producing apparatus, wherein
the dispensing container is connected to a dispensing unit of the mixed drink producing apparatus for conducting the liquid from the dispensing container to the dispensing unit,
the dispensing unit has a dispensing opening, from which the mixed drink can be dispensed, and
the dispensing opening is adjustable in its opening width and/or its angular position for manipulating the orientation of the jet of the liquid after the dispensing opening.

16. A method for producing and dispensing a mixed drink with a mixed drink producing apparatus having the following steps of:
providing a dispensing container, which is formed for receiving a liquid addable to a mixed drink by the mixed drink producing apparatus and
providing a dispensing unit of the mixed drink producing apparatus,
connecting the dispensing container to the dispensing unit for conducting the liquid from the dispensing container to the dispensing unit,
dispensing a jet of the at least one liquid from a dispensing opening of the dispensing unit, and
dispensing an addition medium from a capsule separate from the dispensing container from the capsule for producing the mixed drink, wherein
manipulating the jet of the liquid in its orientation by a manipulation unit of the mixed drink producing apparatus in defined manner such that the jet meets with the jet of the addition medium after exit from the dispensing opening in a defined height position.
